(19) United States
(12) Patent Application Publication
(10) Pub. No.: US 2016/0224955 A1
(43) Pub. Date: Aug. 4, 2016

(54) Method and system for online in-store transactions

(71) Applicant: JDBW Holding, LLC, Austin, TX (US)

(72) Inventors: John Domeracki, Austin, TX (US); Brian Woodruff, San Angelo, TX (US)

(73) Assignee: JDBW Holding, LLC, Austin, TX (US)

(21) Appl. No.: 15/016,236

(22) Filed: Feb. 4, 2016

Related U.S. Application Data
(60) Provisional application No. 62/112,004, filed on Feb. 4, 2015.

(51) Int. Cl. G06Q 20/12; G06Q 30/06; G06Q 20/32; G06Q 20/20

(52) U.S. Cl. CPC G06Q 20/12; G06Q 20/202; G06Q 20/208; G06Q 20/203; G06Q 30/0635; G06Q 20/3274

(57) ABSTRACT

Methods and systems for online in-store transactions are described. In one embodiment, a method may include receiving, at a communication interface, a selection of an item to a virtual shopping cart of an online retail site. The method may also include receiving, at a communication interface, a selection of a pay in-store option from a checkout window of the online retail site. Additionally, the method may include generating, with a data processor, coded transaction information in response to the received selection of the item and selection of the pay in-store option. In such an embodiment, the method may include communicating the coded transaction information over the communication interface to a remote device for presentation to an in-store point of sale device.

### CROSS-REFERENCE TO RELATED APPLICATIONS

This application claims priority to U.S. Provisional Patent No. 62/112,004 entitled “Online-Instore Transactions,” filed on 4 Feb. 2015, which is incorporated herein in its entirety.

### FIELD

This disclosure relates generally to retail sales systems, and more specifically, to online in-store transactions.

### BACKGROUND

The goal of many retailers in today's world is to integrate their brick-and-mortar, online, and mobile shopping experiences to make it seamless for the customer. This is becoming increasingly more common through a variety of methods such as giving employees the ability to shop the website in-store for customers, being able to add online purchases to brick-and-mortar transactions, or by allowing customers to pick up online purchases in-store. The reality of the retail industry is that for the overwhelming majority of retailers, their online marketplace may have a significantly higher and more diverse inventory/SKU count than their brick and mortar stores.

### SUMMARY

Methods and systems for online in-store transactions are described. In one embodiment, a method may include receiving, at a communication interface, a selection of an item to a virtual shopping cart of an online retail site. The method may also include receiving, at a communication interface, a selection of a pay in-store option from a checkout window of the online retail site. Additionally, the method may include generating, with a data processor, coded transaction information in response to the received selection of the item and selection of the pay in-store option. In such an embodiment, the method may include communicating the coded transaction information over the communication interface to a remote device for presentation to an in-store point of sale device.

An embodiment of a system may include an information handling system configured to receive a selection of an item to a virtual shopping cart of an online retail site, receive a selection of a pay in-store option from a checkout window of the online retail site, generate coded transaction information in response to the received selection of the item and selection of the pay in-store option, and communicate the coded transaction information to a remote device for presentation to an in-store point of sale device. Additionally, the system may include a mobile device configured to receive coded transaction information from the online retail site, and display the coded transaction information. Additionally, the system may include an in-store point of sale configured to scan the coded transaction information from the mobile device in response to a user presenting the mobile device at the in-store point of sale, and enable the user to pay for the item at the in-store point of sale in response to the scan of the coded transaction information.

An embodiment of an apparatus may include a communication interface configured to receive a selection of an item to a virtual shopping cart of an online retail site, receive a selection of a pay in-store option from a checkout window of the online retail site, and communicate coded transaction information to a remote device for presentation to an in-store point of sale device. Additionally, the apparatus may include a data processor configured to generate the coded transaction information in response to the received selection of the item and selection of the pay in-store option.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a schematic block diagram illustrating one embodiment of a system for online in-store transactions.

FIG. 2 is a schematic block diagram illustrating one embodiment of a system for online in-store transactions.

FIG. 3 is a schematic block diagram illustrating one embodiment of a data handling system for online in-store transactions.

FIG. 4 is a schematic flowchart diagram illustrating one embodiment of a method for online in-store transactions.

FIG. 5 is a screenshot diagram illustrating one embodiment of an application for online in-store transactions.

FIG. 6 is a screenshot diagram illustrating one embodiment of an application for online in-store transactions.

FIG. 7 is a diagram illustrating one embodiment of a mobile application for online in-store transactions.

FIG. 8 is a diagram illustrating one embodiment of a Point-of-Sale application for online in-store transactions.

FIG. 9 is a system diagram illustrating one embodiment of a system for online in-store transactions.

### DETAILED DESCRIPTION

Embodiments of methods and systems for online in-store transactions are described. In an embodiment, the described embodiments allow a user to select a retail item for online purchase while shopping in a brick-and-mortar retail establishment. The described embodiments allow the user to receive coded transaction information, for example in the form of a Quick Response (QR) code, which can be presented at the in-store point of sale for in-store purchase. The in-store Point-of-Sale (POS) may then relay the purchase information to an on-line merchant system for authorization of order fulfillment and shipping. By being able to tap into an online marketplace's inventory in the store and add items only available online to in-store transactions, a retailer can dramatically increase customer conversion.

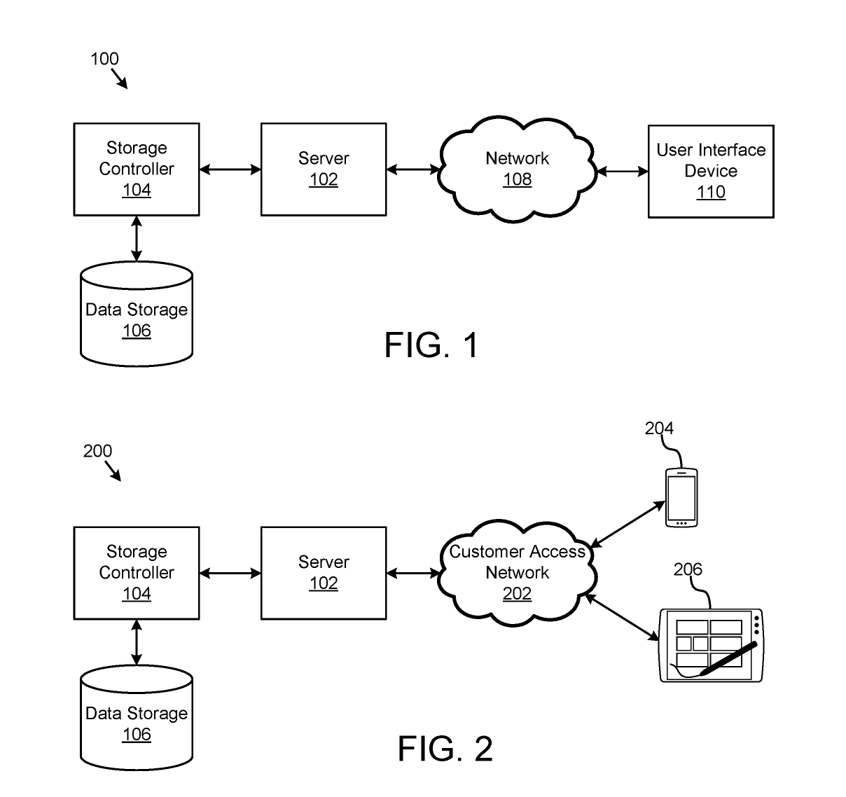

FIG. 1 illustrates one embodiment of a system 100 for online in-store transactions. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108. In a general embodiment, the system 100 may facilitate in-store payment for items available through an on-line merchant.

In various embodiments, the user interface device 110 is referred to broadly and is intended to encompass a suitable processor-based device such as an information handling system, a desktop computer, a laptop computer, a smartphone, a tablet device, a Personal Digital Assistant (PDA), other mobile communication devices, payment interface devices, etc. having access to the network 108. In a further embodiment, the user interface device 110 may access the Internet to access a web application or web service hosted by the server 102 and provide a user interface for enabling a user to enter or receive information. For example, the user may enter item selections on a mobile purchase application, a virtual “shopping cart” of an online retail site, a “checkout window” of an online retail site, or a web-based retail interface hosted by a mobile data device, such as a smartphone or tablet computer.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to receive a request to pay for an item available through an on-line merchant at an in-store point of sale. The server may generate coded transaction information, and communicate the coded transaction information to the user interface device 110 over the network 108.

The data storage device 106 may include a hard disk, including hard disks arranged in a Redundant Array of Independent Disks (RAID) array, an optical storage device, or the like. In one embodiment, the data storage device 106 may store a database of retail items available for purchase through a retail outlet. The data may be arranged in a database and accessible through Structured Query Language (SQL) queries, or other data base query languages or operations.

FIG. 2 illustrates another embodiment of a system 200 for retail add-on sales. In the embodiment of FIG. 2, the system 200 includes a customer access network 202. For example, a customer may enter a brick and mortar retail establishment and connect to the customer access network 202 using, e.g., a smartphone device 204 or a tablet computing device 206. The customer may then use the smartphone device 204 or the tablet computing device 206 to capture or enter inputs including indicia of retail item selections. For example, the customer may use a camera on the smartphone device 202 to capture an image of a Universal Product Code (UPC) barcode, a QR code, or the like. The UPC barcode or QR code may include a SKU number associated with a selected retail item.

For example, a customer is at a Clothing Retailer A and desires a particular jacket in size medium. If the store does not have it available the store might suggest another store within the Clothing Retailer A chain that does have it in stock, a competitive store that may have it in stock, or suggest the online marketplace for Clothing Retailer A. The probability of follow-through on the sale drops dramatically once a seller has taken the customer out of the ‘impulse zone’ of being ready to purchase at the brick-and-mortar location. Some methods currently exist for employees to access their company's online marketplace to help a customer complete the transaction in the store. This usually occurs as a separate transaction if the customer is doing any other in-store shopping. However, there is another method for integrating online sales into brick-and-mortar store sales that is not currently available.

Utilizing a mobile platform such as a smart phone or tablet an employee in a brick-and-mortar may access the online marketplace to find an item not available in-store. From there, a user may select a shipping preference and upon confirming that they do in fact want the item added to their purchase, the mobile platform may generate coded transaction information (e.g., a unique QR code) that may be displayed on a mobile device and scanned at the Point of Sale, thereby adding the item to a POS transaction list of items corresponding to the current (i.e., active) transaction. This prevents any further work on the customer's part; they've successfully completed their shopping experience and the remaining item, or items may be shipped to them under their specified preference. From the retailer's perspective, the company has then successfully captured another sale that almost certainly may have been lost otherwise.

Once the coded transaction information is scanned (e.g., by a store employee scanning a QR code from the display of a mobile device of the user), a POS information handling system, such as a retail computer or server may add information corresponding to the online marketplace item to the current transaction (e.g., by adding item attributes to a POS transaction list of items). In one embodiment, a POS transaction list may include a Stock Keeping Unit (SKU) corresponding to the item, a price (i.e., cost) of the item, a description of the item, a shipping cost, and/or other item attribute values. In an embodiment, adding an item to the POS transaction list may trigger a POS information handling system (e.g., an in-store retail computer or server) to update the current transaction total based on the price of the added item, and upon completion of payment the POS system may send a notification to the online marketplace including shipping instructions and/or a confirmation of payment.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a POS retail computer configured to scan QR codes or bar codes, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

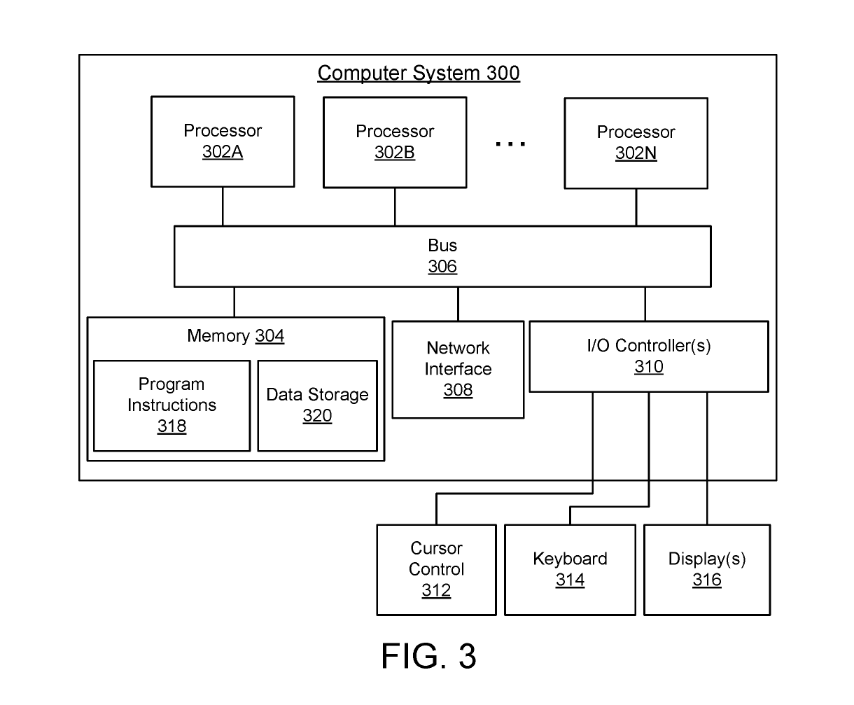

FIG. 3 illustrates an information handling system (IHS), such as IHS 300, which may be suitably configured as a special purpose device for operation of the functions described above with relation to the user interface device 110 or the server 102.

As illustrated, IHS 300 includes one or more processors 302A-N coupled to a system memory 304 via bus 306. IHS 300 further includes network interface 308 coupled to bus 306, and input/output (I/O) controller(s) 310, coupled to devices such as cursor control device 312, keyboard 314, display(s) 316, a camera configured to scan a QR code, and/or a laser bar code scanner. In some embodiments, a given entity (e.g., user interface 110) may be implemented using a single instance of IHS 300, while in other embodiments multiple such systems, or multiple nodes making up IHS 300, may be configured to host different portions or instances of embodiments (e.g., server 102).

In various embodiments, IHS 300 may be a single-processor system including one processor 302A, or a multi-processor system including two or more processors 302A-N (e.g., two, four, eight, or another suitable number). Processor(s) 302A-N may be any processor capable of executing program instructions. For example, in various embodiments, processor(s) 302A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 302A-N may commonly, but not necessarily, implement the same ISA. Also, in some embodiments, at least one processor(s) 302A-N may be a graphics processing unit (GPU) or other dedicated graphics-rendering device.

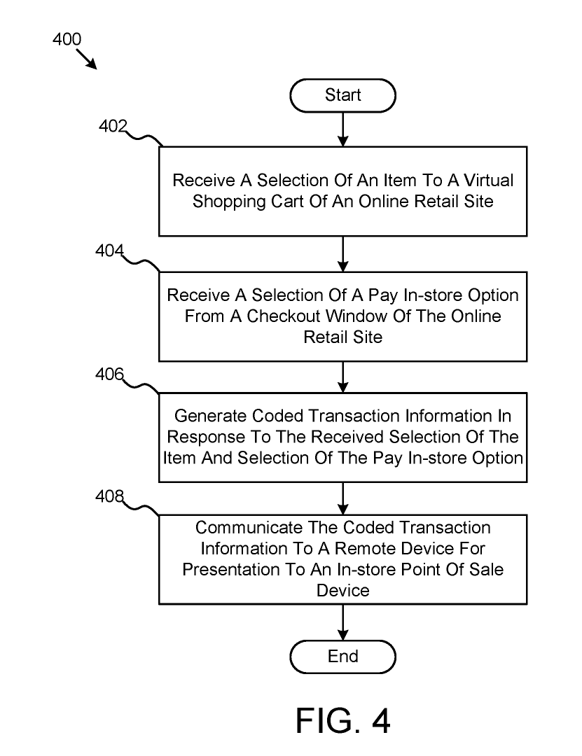

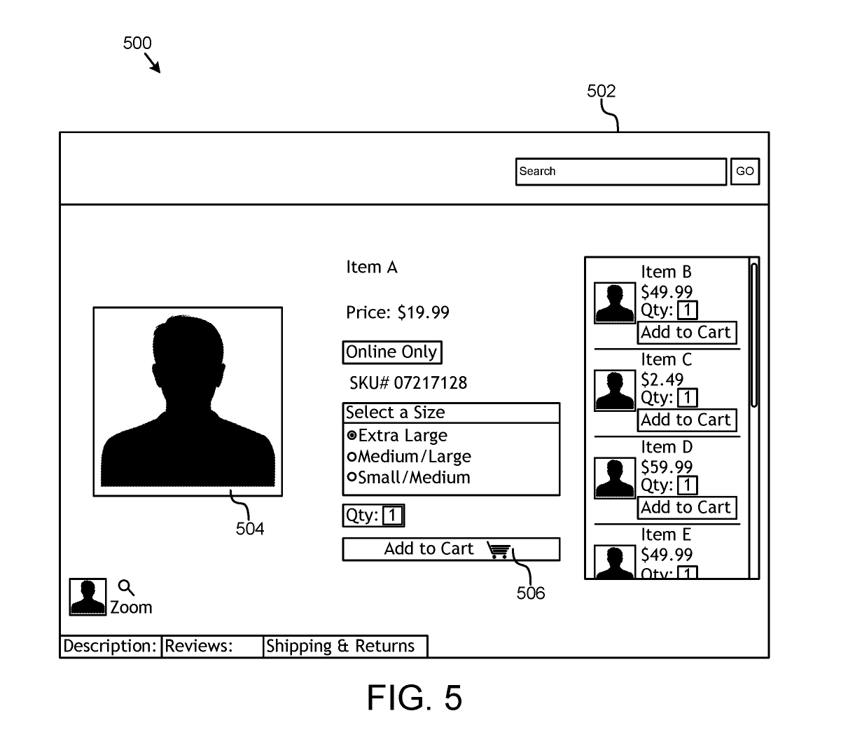

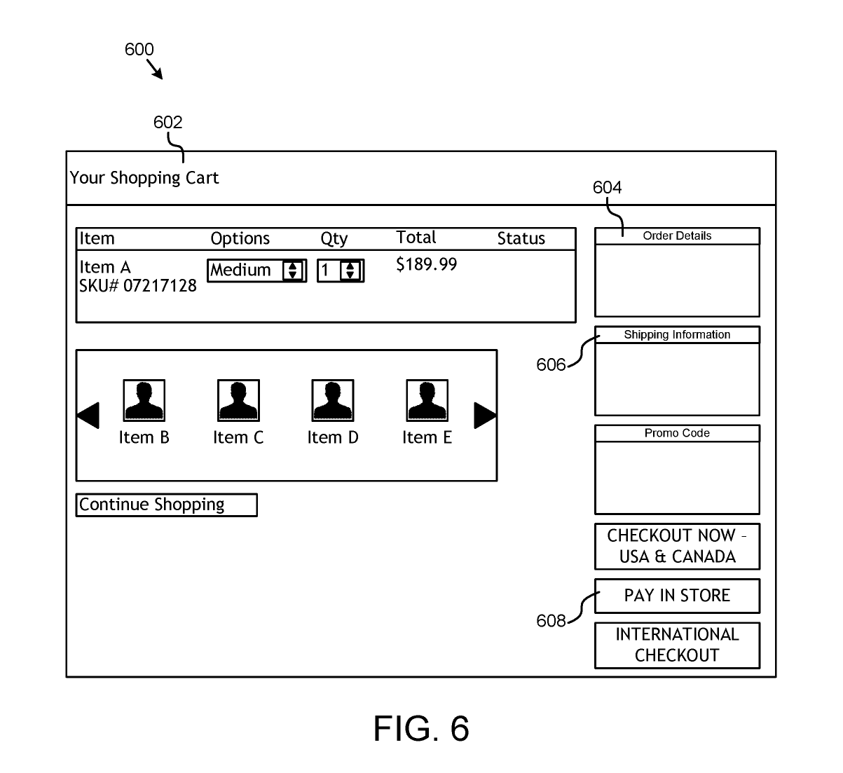

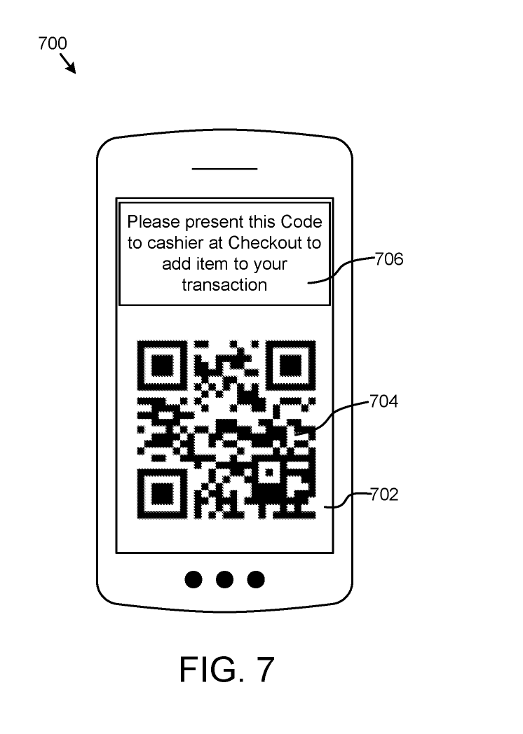

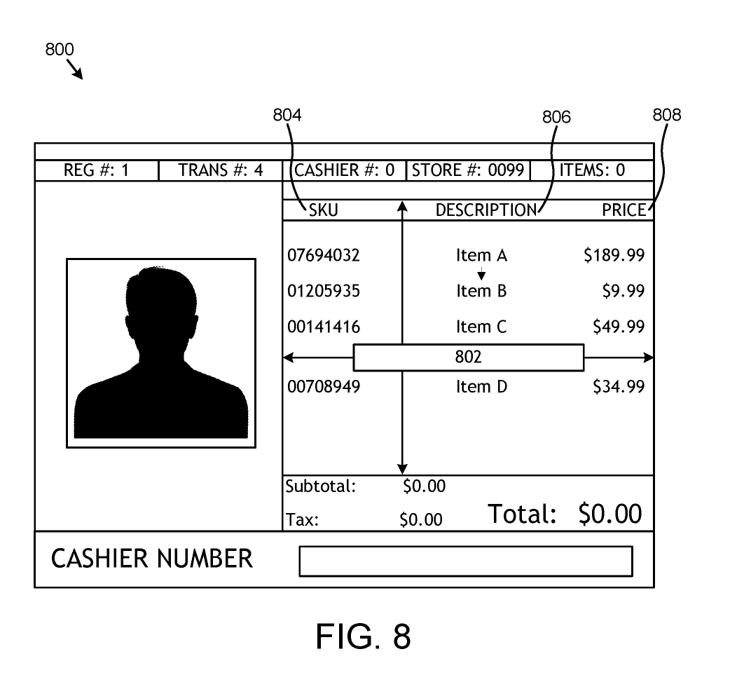

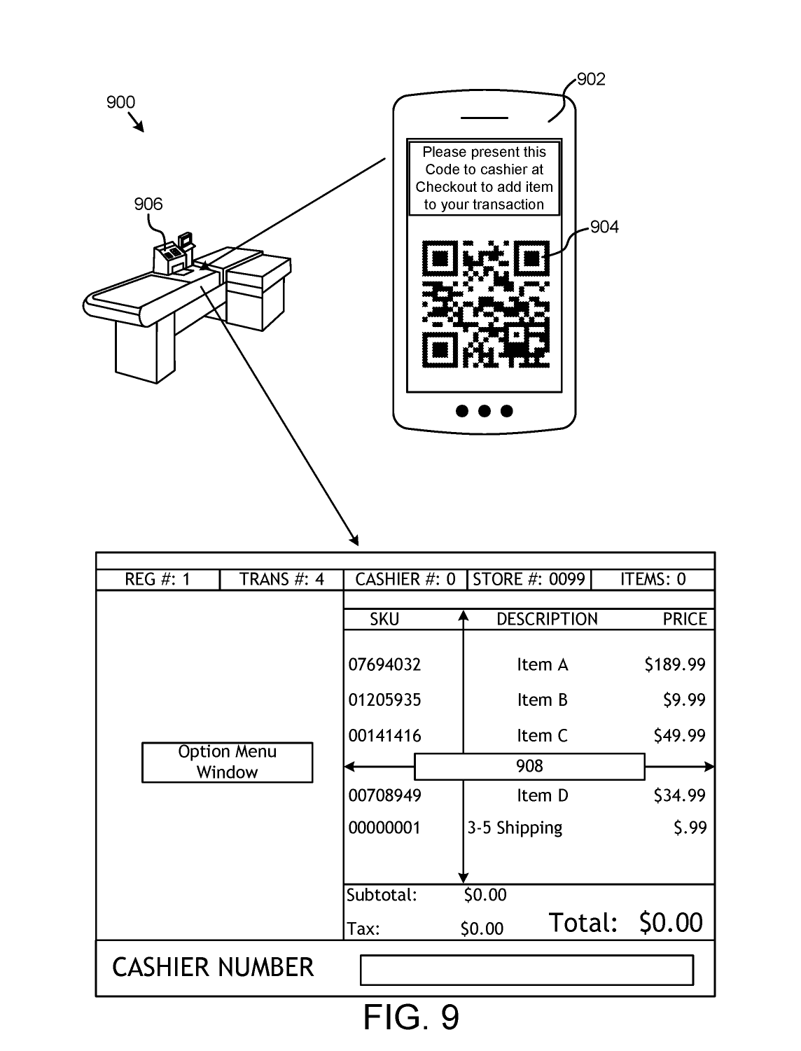

System memory 304 may be configured to store program instructions and/or data accessible by processor(s) 302A-N. For example, memory 304 may be used to store a software program and/or database shown in FIG. 4, FIG. 5, FIG. 6, FIG. 7, FIG. 8, and/or FIG. 9. In various embodiments, system memory 304 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 304 as program instructions 318 and data storage 320, respectively. In other embodiments, program instructions and/or data may be received, sent or stored upon different types of computer-accessible media or on similar media separate from system memory 304 or IHS 300. Generally speaking, a computer-accessible medium may include any tangible, non-transitory storage media or memory media such as electronic, magnetic, or optical media—e.g., disk or CD/DVD-ROM coupled to IHS 300 via bus 306, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 306 may be configured to coordinate I/O traffic between processor 302, system memory 304, and any peripheral devices including network interface 308 or other peripheral interfaces, such as an image sensor (i.e., camera) configured to scan a QR code and/or a laser bar code scanner, connected via I/O controller(s) 310. In some embodiments, bus 306 may perform any necessary protocol, timing or other data transformations to convert data signals from one component (e.g., system memory 304) into a format suitable for use by another component (e.g., processor(s) 302A-N). In some embodiments, bus 306 may include support for devices attached through various types of peripheral buses, such as a variant of the Peripheral Component Interconnect (PCI) bus standard or the Universal Serial Bus (USB) standard, for example. In some embodiments, the operations of bus 306 may be split into two or more separate components, such as a north bridge and a south bridge, for example. In addition, in some embodiments some or all of the operations of bus 306, such as an interface to system memory 304, may be incorporated directly into processor(s) 302A-N.

Network interface 308 may be configured to allow data to be exchanged between IHS 300 and other devices, such as other computer systems attached to server 102, for example. In various embodiments, network interface 308 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 310 may, in some embodiments, enable connection to one or more display terminals, keyboards, keypads, touch screens, scanning devices, voice or optical recognition devices, or any other devices suitable for entering or retrieving data by one or more IHS 300. Multiple input/output devices may be present in IHS 300 or may be distributed on various nodes of IHS 300. In some embodiments, similar I/O devices may be separate from IHS 300 and may interact with IHS 300 through a wired or wireless connection, such as over network interface 308.

As shown in FIG. 3, memory 304 may include program instructions 318, configured to implement certain embodiments described herein, and data storage 220, comprising various data accessible by program instructions 318. In an embodiment, program instructions 318 may include software elements of embodiments illustrated in FIG. 4, FIG. 5, FIG. 6, FIG. 7, FIG. 8, and/or FIG. 9. For example, program instructions 318 may be implemented in various embodiments using any desired programming language, scripting language, or combination of programming languages and/or scripting languages. Data storage 220 may include data that may be used in these embodiments such as, for example server 102 or user interface device 110. In other embodiments, other or different software elements and data may be included.

A person of ordinary skill in the art will appreciate that IHS 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

Embodiments of server 102 described in FIG. 1, FIG. 2, and FIG. 4 may be implemented in a computer system that is similar to IHS 300. In one embodiment, the elements described in FIG. 1, FIG. 2, and FIG. 4 may be implemented in discrete hardware modules. Alternatively, the elements may be implemented in software-defined modules which are executable by one or more of processors 302A-N, for example.

FIG. 4 is a schematic flowchart diagram illustrating one embodiment of a method 400 for online in-store transactions. At block 402, the method 400 includes receiving a selection of an item to a virtual shopping cart of an online retail site. At block 404, the method includes receiving a selection of a pay in-store option from a checkout window of the online retail site. At block 406, the method 400 includes generating coded transaction information in response to the received selection of the item and the selection of the pay in-store option. At block 408, the method 400 also include communicating the coded transaction information to a remote device for presentation to an in-store point of sale device.

In another embodiment, a method may include locating an item in an online catalogue and adding, with an IHS (e.g., a smart phone, PDA, or computer), an item to a virtual shopping cart of an online retail site and selecting, with the IHS, a pay in-store option from a checkout window of the online retail site. In an embodiment, the method may further include receiving, with a mobile device, coded transaction information from the online retail site. In various embodiments, the coded transaction information (e.g., a QR code) may be delivered to the customer via an in-app profile, an email, hyperlinked in a SMS message, or the like as shown in FIG. 7.

In an embodiment, a method may include presenting the mobile device at an in-store point of sale, wherein the mobile device is configured to display the coded transaction information. For example, a customer may display the QR code on their mobile phone and show the image of the QR code to the cashier in the store. Such an embodiment may further include paying for the item at the in-store point of sale in response to a scan of the coded transaction information from the mobile device. For example, the cashier may scan the image of the QR code from the mobile phone, thereby triggering the POS information handling system to contact a server of the online retail site and receive item attribute information that the POS information handling system subsequently adds to a POS transaction list. In various embodiments, the item attribute information added to the POS transaction list may include a SKU of the item, a price of the item, a description of the item, a shipping preference, and/or a shipping cost of the item.

In an embodiment, a customer may be shopping in a physical “brick-and-mortar” retail establishment. The customer may have a desire to purchase one or more item(s) that may in some combination may be available in-store or online only. The customer or employees may find the item on the online marketplace, add the item to a virtual shopping cart of the online retail site, and select a “pay in-store” option on the checkout page of the online retail site, thereby causing the online retail site to generate coded transaction information and send the coded transaction information to the customer for use at the in-store register. This system enables the customer to complete the purchase in-store and allows the retailer to capture a sale that otherwise might potentially be lost.

If a customer wants a particular item that is not available in-store, the customer may utilize a mobile platform to find the item on an online marketplace. In an embodiment, an initial step may be to “Add to Cart” (e.g., to a virtual shopping cart of an online retail site) as shown in FIG. 5.

FIG. 5 is a screenshot diagram illustrating one embodiment of an application 500 for online in-store transactions. As depicted, the application 500 includes an online retail site 502, an item 504, and an “add to cart” button 506. In an embodiment, a user may browse online retail site 502 via an information handling system, such as a smart phone, tablet, computer, or the like. If the user desires to purchase item 504, the user may click on “add to cart” button 506 to add item 504 to a virtual online shopping cart of online retail site 502.

After adding one or more items to the virtual shopping cart of the online retail site, a customer may proceed to a payment screen and select an option to “PAY IN STORE” as shown in FIG. 6.

FIG. 6 is a screenshot diagram illustrating one embodiment of an application 600 for online in-store transactions. As depicted, the application 600 includes a checkout window 602 of an online retail site, an order summary 604, shipping information 606, and a “pay in store” button 608. A user may review information in checkout window 602, such as order summary 604 and shipping information 606 for accuracy and/or make adjustments (e.g., adding items, removing items, and/or revising shipping preferences) prior to deciding on a payment option. In one embodiment, order summary 604 may include a list of items currently in the user's virtual online shopping cart, as well as purchase price information. In an embodiment, checkout window 602 may also include shipping information 606, which may include a shipping preference selection (e.g., ground or next-day air), an estimated delivery date, and/or an estimated shipping cost. If a user approves of the information listed in order summary 604 and shipping information 606, the user may use an IHS to click on “pay in store” button 608 if the user wishes to pay for the item at a brick and mortar store associated with the online retail site.

In response to the user selecting the “PAY IN STORE” option, an information handling system of the online retailer (e.g., a server or computer system) may generate coded transaction information (e.g., a QR code) with information pertaining to the transaction, including, but not limited to, a purchase amount, a shipping amount & shipping preference. In one embodiment, the information handling system of the retailer may add a temporary “hold” status to the order that enables the item to be held for up to 2 hours while the customer continues to shop. In various embodiments, the coded transaction information (e.g., a QR code) may be delivered to the customer via an in-app profile, an email, hyperlinked in a SMS message, or the like as shown in FIG. 7.

FIG. 7 is a diagram illustrating one embodiment of a mobile application 700 for online in-store transactions. In an embodiment, mobile application 700 may include a mobile device, such as a smartphone, having a display 702. Display 702 may be configured to display coded transaction information 704 corresponding to descriptive information identifying an item, such as item 505 of FIG. 5, that a user has selected for purchase using a “pay in store” option (e.g., via “pay in store” button 608 of FIG. 6. In various embodiments, coded transaction information 704 may include a QR code, a bar code, or another type of coded symbol configured to be scanned by a retail POS information handling system. In one embodiment, coded transaction information 706 may also include a text prompt 706 configured to instruct a user to present an image of coded transaction information 704 to a cashier at a brick and mortar POS location. For example, in an embodiment text prompt 706 may read, “Please present this code to cashier at checkout to add item to your transaction.”

Once the customer reaches the point of sale their in-store items may be scanned as shown in FIG. 8. At any point in the transaction, the cashier may scan the coded transaction information (e.g., a QR code) from the mobile device to add the corresponding item information to the active transaction (e.g., to a POS transaction list) as shown in FIG. 9. When the customer has completed their transaction, the in-store purchase and the online purchase have been completed seamlessly, and the customer may receive automated email notifications about the progress of the order processing status and/or shipping information corresponding to their transaction.

FIG. 8 is a diagram illustrating one embodiment of a Point-of-Sale application 800 for online in-store transactions. In one embodiment, POS application 800 may include a POS transaction list 802 having data corresponding to one or more items that a user wishes to physically purchase in-store and/or that a user has selected to pay for in-store via an online retail site. In various embodiments, POS transaction list 802 may include SKU information 804, item description information 806, item price information 808, shipping preferences, and/or shipping cost information.

FIG. 9 is a system diagram illustrating one embodiment of a system 900 for online in-store transactions. In an embodiment, system 900 may include a mobile device 902 (e.g., a smart phone or tablet) configured to display coded transaction information 904 (e.g., a QR code). A user may present mobile device 902 to a cashier during checkout, and the cashier may utilize a POS information handling system 906 to scan the image of the coded transaction information 904 from the display of mobile device 902. In response to the cashier scanning coded transaction information 904, the POS information handling system updates POS transaction list 908 by adding the one or more item(s) corresponding to coded transaction information 904 to the list of items being paid for by the customer, as displayed on POS transaction list 908. In one embodiment, POS information handling system 906 may contact an information handling system, such as a server, of an online retail site to help decode the item information corresponding to coded transaction information 904. In an embodiment, the POS information handling system 906 may contact an information handling system, such as a server, of the online retail site to confirm to the online retail site that the customer has paid for one or more item(s) in the store, thereby signaling the online retail site to initiate the shipment process to the customer based on any customer-selected shipping preferences. In one embodiment, the online retail site may send automated emails and/or SMS messages to the customer to update the customer on the status of the expected delivery of the item(s) being shipped.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Additional details associated with the presented embodiments are shown in the attached drawings.

1. A method of online in-store transactions, comprising:
receiving, at a communication interface, a selection of an item to a virtual shopping cart of an online retail site;
receiving, at a communication interface, a selection of a pay in-store option from a checkout window of the online retail site;
generating, with a data processor, coded transaction information in response to the received selection of the item and selection of the pay in-store option;
communicating the coded transaction information over the communication interface to a remote device for presentation to an in-store point of sale device.

2. The method of claim 1, wherein the coded transaction information further comprises a Quick Response (QR) code.

3. The method of claim 1, wherein the coded transaction information further comprises a bar code.

4. The method of claim 1, wherein the coded transaction information further comprises text prompting a user to present the coded transaction information to a cashier at checkout.

5. The method of claim 1, further comprising adding, with an in-store point of sale information handling system, a Stock Keeping Unit (SKU) of the item from the online retail site to a point of sale transaction list.

6. The method of claim 5, further comprising adding, with the in-store point of sale information handling system, a price of the item from the online retail site to the point of sale transaction list.

7. The method of claim 6, further comprising adding, with the in-store point of sale information handling system, a description of the item from the online retail site to the point of sale transaction list.

8. A system for online in-store transactions, comprising:
an information handling system configured:
receive a selection of an item to a virtual shopping cart of an online retail site;
receive a selection of a pay in-store option from a checkout window of the online retail site;
generate coded transaction information in response to the received selection of the item and selection of the pay in-store option;
communicate the coded transaction information to a remote device for presentation to an in-store point of sale device; and
a mobile device configured to:
receive coded transaction information from the online retail site; and
display the coded transaction information; and
an in-store point of sale configured to:
scan the coded transaction information from the mobile device in response to a user presenting the mobile device at the in-store point of sale; and
enable the user to pay for the item at the in-store point of sale in response to the scan of the coded transaction information.

9. The system of claim 8, wherein the coded transaction information further comprises a Quick Response (QR) code.

10. The system of claim 8, wherein the coded transaction information further comprises a bar code.

11. The system of claim 8, wherein the coded transaction information further comprises text prompting a user to present the coded transaction information to a cashier at checkout.

12. The system of claim 8, further comprising adding, with an in-store point of sale information handling system, a Stock Keeping Unit (SKU) of the item from the online retail site to a point of sale transaction list.

13. The system of claim 12, further comprising adding, with the in-store point of sale information handling system, a price of the item from the online retail site to the point of sale transaction list.

14. The system of claim 13, further comprising adding, with the in-store point of sale information handling system, a description of the item from the online retail site to the point of sale transaction list.

15. An apparatus for online in-store transactions, comprising:
a communication interface configured to:
receive a selection of an item to a virtual shopping cart of an online retail site;
receive a selection of a pay in-store option from a checkout window of the online retail site; and
communicate coded transaction information to a remote device for presentation to an in-store point of sale device; and
a data processor configured to generate the coded transaction information in response to the received selection of the item and selection of the pay in-store option.

16. The apparatus of claim 15, wherein the coded transaction information further comprises a Quick Response (QR) code.

17. The apparatus of claim 15, wherein the coded transaction information further comprises a bar code.

18. The apparatus of claim 15, further comprising adding, with an in-store point of sale information handling system, a Stock Keeping Unit (SKU) of the item from the online retail site to a point of sale transaction list.

19. The apparatus of claim 18, further comprising adding, with the in-store point of sale information handling system, a price of the item from the online retail site to the point of sale transaction list.

20. The apparatus of claim 19, further comprising adding, with the in-store point of sale information handling system, a description of the item from the online retail site to the point of sale transaction list.
